(19) United States
(12) Patent Application Publication
(10) Pub. No.: US 2013/0051573 A1
(43) Pub. Date: Feb. 28, 2013

(54) METHOD FOR FITTING A HEARING AID, AND HEARING AID

(71) Applicants: Makoto NISHIZAKI, Tokyo (JP); Eiji NOGUCHI, Osaka (JP)

(72) Inventors: Makoto NISHIZAKI, Tokyo (JP); Eiji NOGUCHI, Osaka (JP)

(21) Appl. No.: 13/585,154

(22) Filed: Aug. 14, 2012

(30) Foreign Application Priority Data
Aug. 24, 2011 (JP) 2011-182399

(51) Int. Cl. H04R 29/00

(52) U.S. Cl. 381/60

(57) ABSTRACT

This method for fitting a hearing aid involves displaying the coordinate positions of parameters produced on the basis of a plurality of fitting theories, and the evaluation results for these parameters, on a display section 5, and using those parameters with good evaluation results to set a fine adjustment recommended area 12A in the coordinate positions of the display section 5. Manipulated marks 13 are displayed at the coordinate positions that have been manipulated within the fine adjustment recommended area 12A, selection candidate displays 14 are put at the coordinate positions where favorable evaluations were obtained, out of the coordinate positions where the manipulated marks 13 have been displayed, and the selected coordinate position parameters out of the coordinate positions where the selection candidate displays 14 have been displayed are registered as fitting parameters in a hearing aid 1.

### BACKGROUND OF THE INVENTION

1. Field of the Invention

The present invention relates to a method for fitting a hearing aid, and more particularly to a method with which a user can adjust a hearing aid himself.

2. Description of the Related Art

In the fitting of a hearing aid, it is becoming increasingly common for the user of the hearing aid to be present at the fitting.

The fitting of a hearing aid can be extremely difficult, and the fitting will end up being unsatisfactory to the user unless there is good communication between the fitter and the user.

In view of this, there is a method in which the fitter performs a first fitting, and fine tuning is performed by the user himself, so that the user will be better satisfied with the result.

More specifically, after the first fitting, the user manipulates countless fitting points provided on a screen, and evaluates how well he can hear at that point, which allows the user to achieve the fitting best suited to his needs from among the countless fitting points provided.

For example, Patent Literature 1 below discusses a fitting method in which fitting points are manipulated on a screen.

In Patent Literature 1, because hearing aids are used in a wide variety of locations, the optimal parameters under a variety of environments are considered, with the goal of finding the parameters that suit the user's preferences. This method involves finding a good balance of adjustment parameters on a two-dimensional plane made up of the optimal parameters under a plurality of environments.

In Patent Literature 2 below, parameters produced by a genetic algorithm are evaluated, and the parameters with which the highest score was obtained are arranged in a matrix so that a listening comparison can be conducted at the end.

### CITATION LIST

### Patent Literature

Patent Literature 1: Japanese Laid-Open Patent Application 2001-238294

Patent Literature 2: Japanese Laid-Open Patent Application 2001-175637

### SUMMARY

In Patent Literature 1 above, fine adjustment is carried out for a variety of environments, but when the goal is to adjust the hearing aid to suit the user's preferences in regard to his basic hearing, then in order to adjust the basic hearing of sounds, the adjustment must include not only parameters that allow the user to hear words clearly and the user's preferred sound quality, in addition to a space constituted on the basis of optimal parameters found for various environments as in prior art, but also parameters that cannot be heard clearly or are not to the user's liking, for example, so that the good parameters can be distinguished, and the user must decide on these.

With the method in Patent Literature 1, which utilizes a two-dimensional space constituted on the basis of optimal parameters under a variety of environments, it is difficult to realize a search space as a two-dimensional space so that the user will be comfortable with adjustment of basic hearing. Also, obtaining optimal parameters under various environments itself ends up taking a long time.

With Patent Literature 2, parameters arranged in a matrix are just those with a high score, and there is no hearing comparison with respect to the realistic parameters or parameters that are not of the user's preference. Accordingly, fine adjustment of hearing that is close to these parameters cannot be performed to the user's satisfaction. And finding parameters that give a high score takes a long time in the first place.

In view of this, the present invention provides a hearing aid fitting apparatus with which it is a simple matter to produce the space the user is looking for, and the basic hearing of the user can be simply and quickly checked by the user himself, which makes the process more convenient.

To achieve the stated object, the present invention comprises the steps of displaying the coordinate positions of a plurality of adjustment parameters and the results of evaluating these parameters on a display section, using those parameters with a good evaluation result to set a fine adjustment recommended area in the coordinate positions on the display section, displaying manipulated marks at the manipulated coordinate positions within the fine adjustment recommended area, putting selection candidate displays at the coordinate positions where favorable evaluations were obtained out of the coordinate positions where the manipulated marks have been displayed, and registering the selected coordinate position parameters, out of the coordinate positions where the selection candidate displays have been put, as fitting parameters in a hearing aid.

The present invention makes it more convenient to do the fitting of a hearing aid.

Specifically, with the present invention, since a fine adjustment recommended area is set in coordinate positions on a display section, the coordinate positions manipulated by the user can be narrowed down to a more suitable number. As a result, hearing aid fitting takes less time and the process is more convenient.

### BRIEF DESCRIPTION OF DRAWINGS

FIG. 1 shows a method for fitting a hearing aid pertaining to Embodiment 1 of the present invention;

FIG. 2 is a diagram illustrating the fitting method in FIG. 1;

FIG. 3 is a diagram illustrating the fitting method in FIG. 1;

FIG. 4 is a diagram illustrating the fitting method in FIG. 1;

FIG. 5 is a diagram illustrating the fitting method in FIG. 1;

FIG. 6 is a configuration diagram illustrating the fitting method in FIG. 1; and

FIG. 7 is a flowchart illustrating the fitting method in FIG. 1.

### DETAILED DESCRIPTION OF THE INVENTION

An embodiment of the present invention will now be described in detail along with the drawings. Embodiment 1

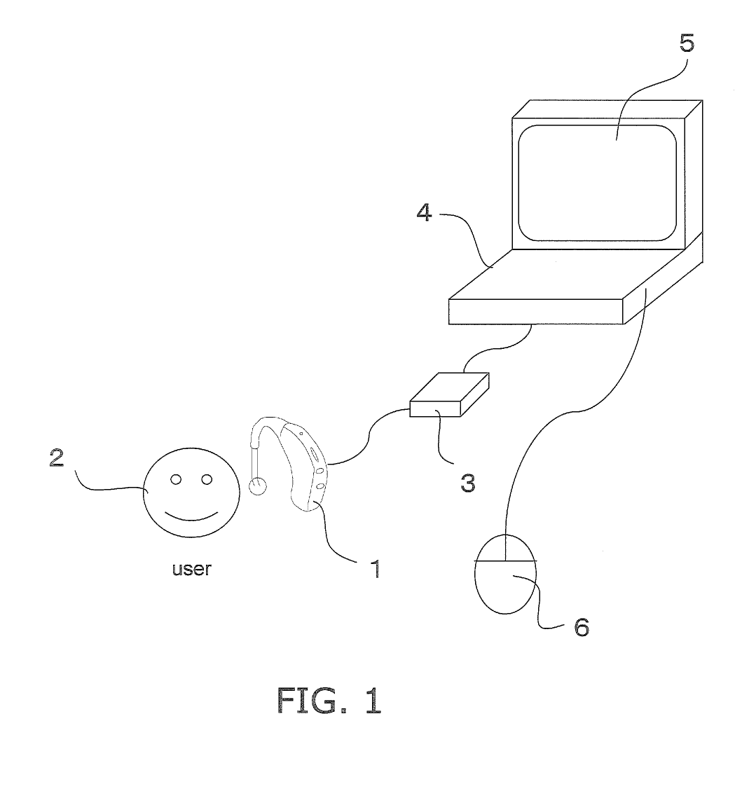

In FIG. 1, a hearing aid 1 is connected to a fitting device 4 via a connector box 3 and fitting is performed in a state in which the hearing aid 1 is mounted to the hear of a user 2.

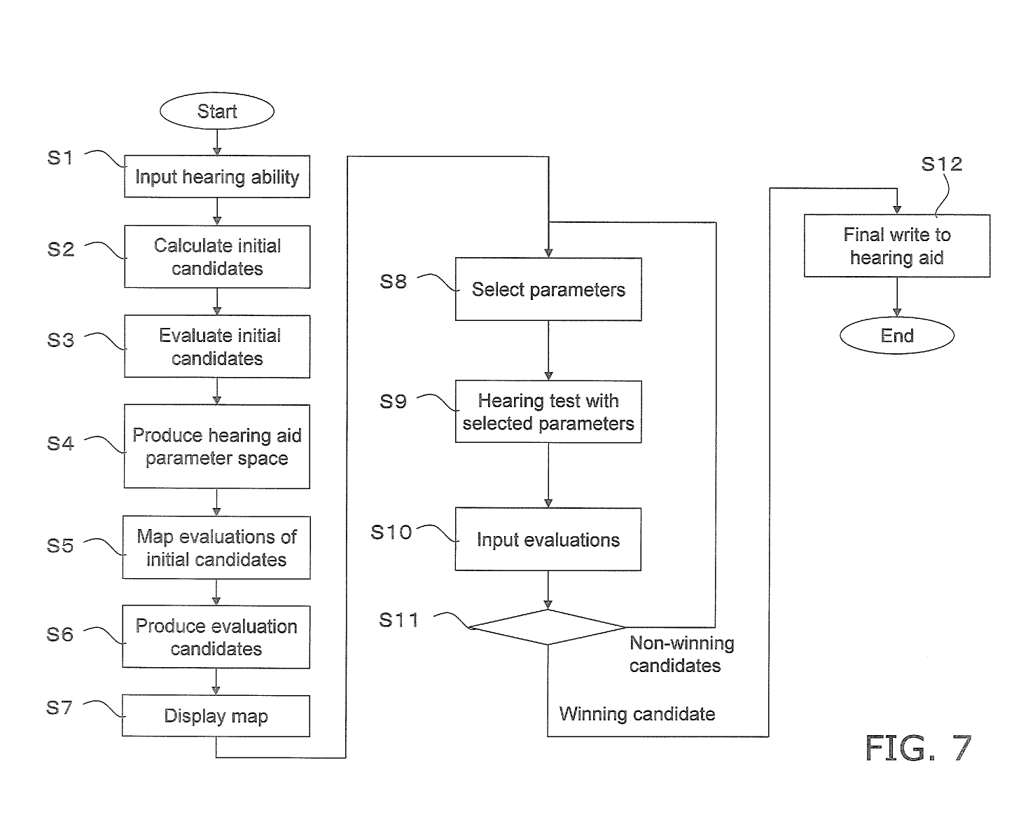

A display section 5 is provided to the fitting device 4. An input section 6 is also connected to the fitting device 4. In the configuration in FIG. 1, in the fitting of the hearing aid 1, an audio signal outputted from the fitting device 4 to a speaker (not shown) is supplied from a microphone 7 of the hearing aid 1 to an A/D converter 8, a hearing aid processor 9, a D/A converter 10, and a receiver 11. The user 2 then evaluates fitting processing (S1, S2, and S3 in FIG. 7).

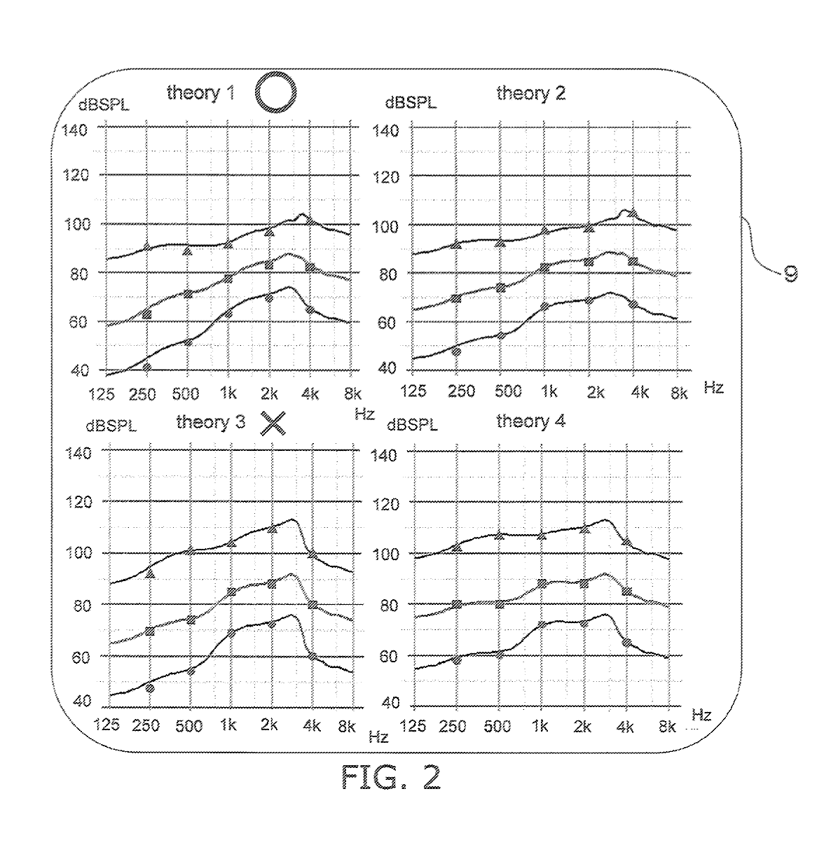

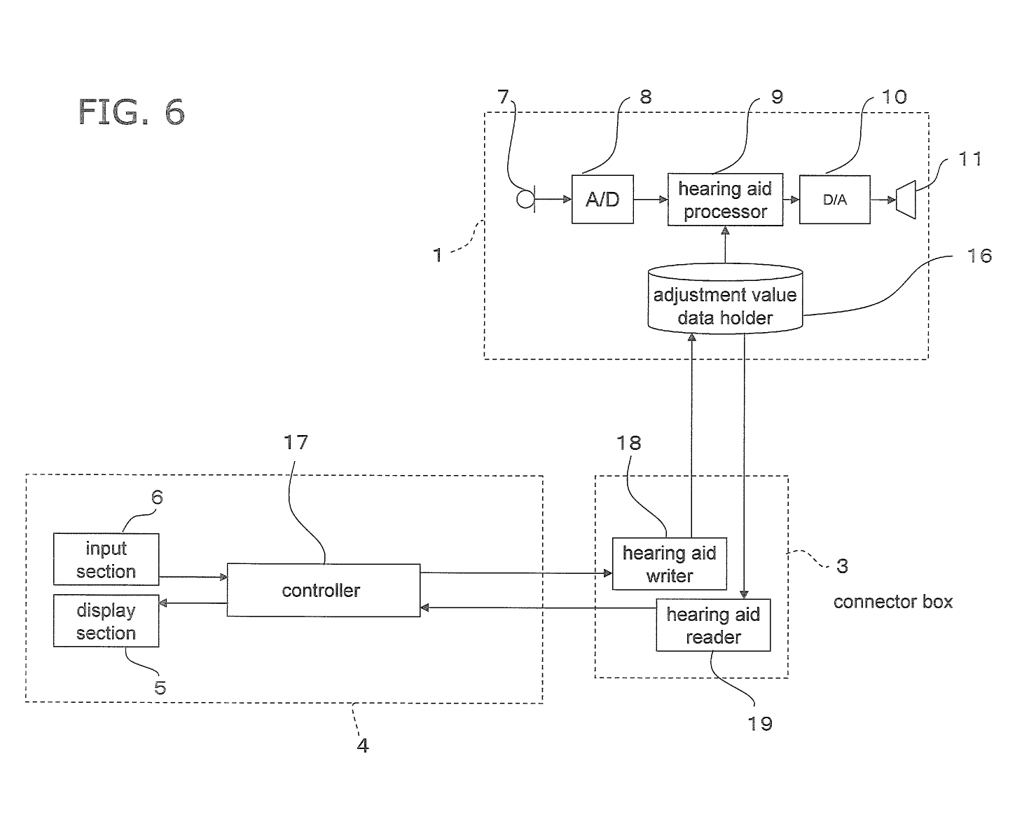

In this embodiment, parameters based on well known fitting theories, such as NAL-NL1, DSL, FIG. 6, or IHAFF, on the basis of the hearing ability of the user 2, are used as first fitting parameters by the hearing aid processor 9 of the hearing aid 1. These first parameters based on four fitting theories are evaluated by the user 2 at this point, as shown in FIG. 2.

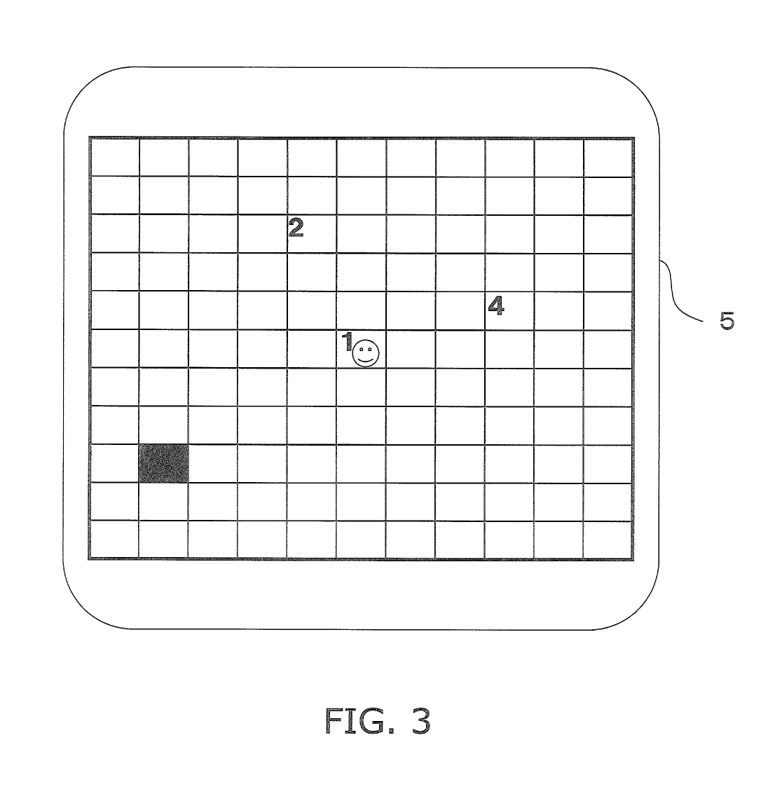

In this state, as shown in FIG. 3, the fitter displays a two-dimensional parameter map, in which parameters are arranged in cells, on the display section 5 of the fitting device 4, and also displays the coordinate positions of parameters produced on the basis of a plurality of fitting theories, and the results of evaluating these parameters.

More specifically, in this case, of the four fitting theories, the user 2 picks No. 1 as the best, and No. 3 as the least favorable. Thus, a display indicating most favorable is made at the coordinate position of the parameters produced on the basis of the No. 1 fitting theory, and a display indicating unfavorable is made at the coordinate position of the parameters produced on the basis of the No. 3 fitting theory.

The above-mentioned parameter map has close parameters arranged in close cells, and has the parameters arranged so that the hearing is more different in distant cells than in close cells.

More specifically, those parameters with similar output characteristics for each frequency are disposed closer, and those with different characteristics are disposed farther away, making a gradual change on the parameter map. Giving the parameter map this feature allows the user to search for parameters more intuitively.

During production of the parameter map, parameters are produced over a range that allows fine adjustment, centering on parameter values calculated by a fitting theory from the user's hearing ability, or the current adjustment value upon switching to this adjustment mode, and the parameters thus produced are used to produce a predetermined N×N two-dimensional parameter map by means of a self-organized map (SOM) or another such dimensional compression technique. In producing parameters over a range that allows fine adjustment, it is preferable to take into account the limit to output without causing ear damage, the lowest value for output determined from hearing ability, and the like. How the map is produced is not limited to the above-mentioned method involving a self-organized map, and any other method may be used instead, such as multi-dimensional scaling.

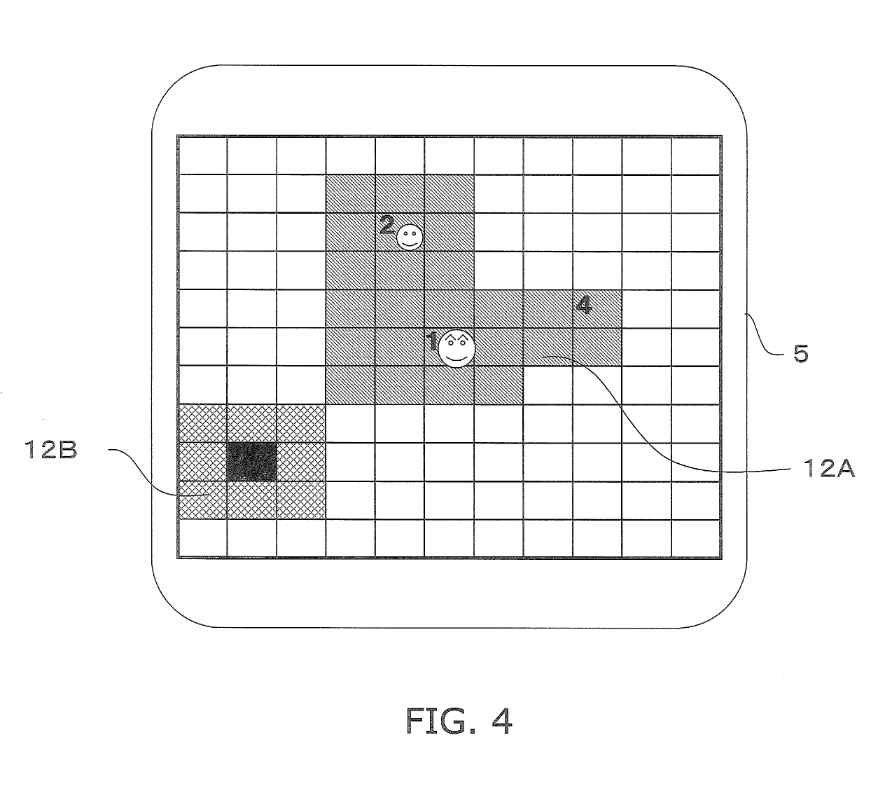

In this embodiment, as shown in FIG. 4 (which follows FIG. 3), a fine adjustment recommended area 12A is set in the coordinate positions on the display section 5 by using the above-mentioned parameters that do not have unfavorable evaluation results, namely, parameter Nos. 1, 2, and 4 (S4, S5, S6, and S7 in FIG. 7). One method that may be used to set the recommended area is to select from among adjacent cells those in which the gain at various frequencies is within ±10 dB. Another method that can be used, for example, is to calculate the distance between vectors on a self-organized map, and select those that fall within a specific range.

Meanwhile, a fine adjustment non-recommended area 12B is set using the unfavorable parameter (No. 3). A method in which the gain at various frequencies is within ±10 dB may be used, for example, for the fine adjustment non-recommended area as well.

The fine adjustment recommended area 12A and the fine adjustment non-recommended area 12B may in some cases be near each other and overlap. If this happens, the recommend area is preferably set so that there is no overlap between the two areas.

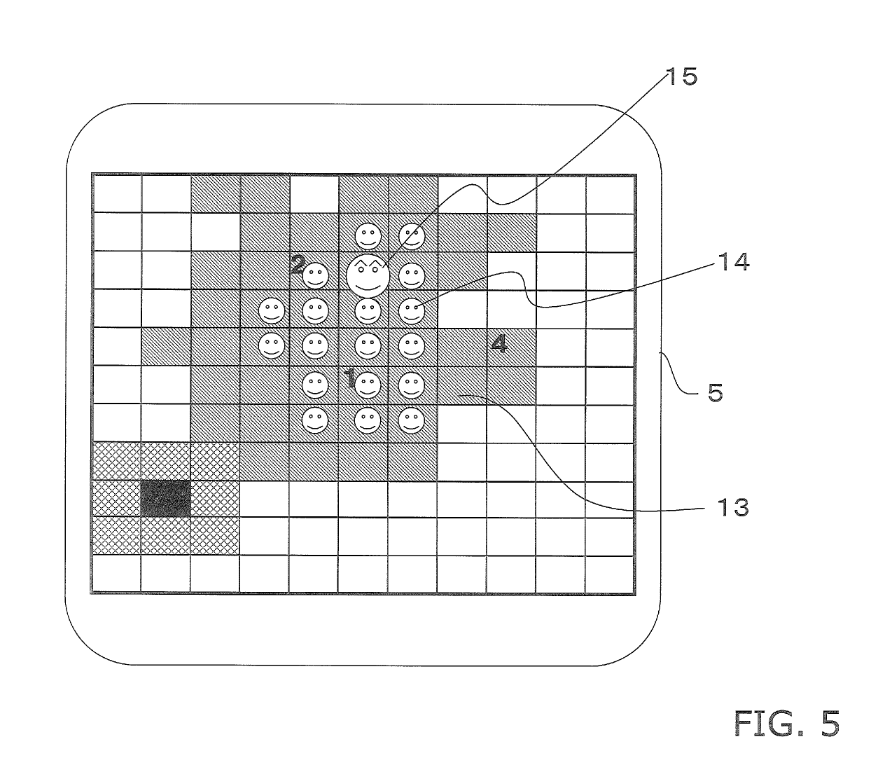

The user 2 looks at the display section 5 in FIG. 4, and basically manipulates the coordinate positions within the fine adjustment recommended area 12A (S8 in FIG. 7). The user 2 then listens to an audio test of audio processed with the parameters at the selected coordinate positions, and as shown in FIG. 5, puts manipulated marks 13 at the coordinate positions that he has manipulated (S9 in FIG. 7).

In this embodiment, the manipulated marks 13 change the color of the coordinate positions, or apply hatching. In FIG. 5, the manipulated marks 13 are put in areas except the fine adjustment recommended area 12A shown in FIG. 4. This is the result of putting the manipulated marks 13 in portions that the user 2 has manipulated just to be sure.

In FIG. 5, selection candidate displays 14 are made at the coordinate positions where favorable evaluations were obtained in the coordinate positions with the manipulated marks 13 (S10 in FIG. 7). Of the coordinate positions with the selection candidate displays 14, the one with the most favorable evaluation is given a selection confirmation display 15. The parameters at the coordinate position with the selection confirmation display 15 are registered as the fitting parameters in an adjustment value data holder 16 of the hearing aid 1 shown in FIGS. 6 (S11 and S12 in FIG. 7).

Of the plurality of selection candidate displays 14, the selection confirmation display 15 that is subsequently selected and put in a coordinate position is displayed in a different form from that of the selection candidate displays 14, as shown in FIG. 5. for example, the color of that coordinate position can be changed, or a character display may be changed.

In this embodiment, as discussed above, the fine adjustment recommended area 12A is set in the coordinate positions on the display section 5. Accordingly, the coordinate positions manipulated by the user 2 are narrowed down to a suitable number. As a result, manipulation time is shortened and the process can be made more convenient.

As shown in FIG. 6, a hearing aid writer 18 and a hearing aid reader 19 of the connector box 3 are connected to a controller 17.

In this embodiment, four fitting theories were utilized in the initial candidate calculation of S2, but the initial candidates are not limited to this method.

For instance, after one initial candidate has been found on the basis of one fitting theory and the user's hearing ability, changes can be made to that initial candidate, such as “emphasize the high band,” or “emphasize the low band,” or “raise the overall gain,” with a plurality of these being produced, and these can be the initial candidates used in S3.

### INDUSTRIAL APPLICABILITY

As discussed above, with the present invention, a fine adjustment recommended area is set in the coordinate positions on the display section, so the coordinate positions manipulated by the user can be narrowed down to a suitable number. As a result, the manipulation time is shorter and the process can be made more convenient. Therefore, this method for fitting a hearing aid is expected to find wide application.

1. A method for fitting a hearing aid, comprising the steps of:
displaying the coordinate positions of a plurality of adjustment parameters and the results of evaluating these parameters, on a display section;
using those parameters with a good evaluation result to set a fine adjustment recommended area in the coordinate positions on the display section;
displaying manipulated marks at the manipulated coordinate positions within the fine adjustment recommended area;
putting selection candidate displays at the coordinate positions where favorable evaluations were obtained, out of the coordinate positions where the manipulated marks have been displayed; and
registering the selected coordinate position parameters, out of the coordinate positions where the selection candidate displays have been put, as fitting parameters in a hearing aid.

2. The method for fitting a hearing aid according to claim 1,
wherein the plurality of adjustment parameters are parameters produced on the basis of a plurality of fitting theories.

3. The method for fitting a hearing aid according to claim 1,
wherein a selection confirmation display that is different from the selection candidate displays is made at a subsequently selected coordinate position, out of the plurality of selection candidate displays.

4. The method for fitting a hearing aid according to claim 1,
wherein parameters with unfavorable evaluation results, out of the plurality of parameters, are used to set a fine adjustment non-recommended area in the coordinate positions of the display section.

5. A hearing aid, which is adjusted using the method for fitting a hearing aid according to claim 1,
the hearing aid comprising a memory that stores fitting parameters that are finally obtained.
